(19) United States
(12) Patent Application Publication
(10) Pub. No.: US 2019/0062215 A1
(43) Pub. Date: Feb. 28, 2019

(54) GYPSUM BOARD WITH ENHANCED STRENGTH, AND RELATED METHODS, SLURRIES, AND COVER SHEETS

(71) Applicant: United States Gypsum Company, Chicago, IL (US)

(72) Inventors: Runhai Lu, Wauconda, IL (US); Yijun Sang, Oak Park, IL (US); Kyle Lucas, Libertyville, IL (US)

(73) Assignee: United States Gypsum Company, Chicago, IL (US)

(21) Appl. No.: 15/971,766

(22) Filed: May 4, 2018

Related U.S. Application Data
(60) Provisional application No. 62/550,373, filed on Aug. 25, 2017.

(51) Int. Cl. C04B 28/14; C04B 24/26; C04B 24/38; B32B 13/08

(52) U.S. Cl. CPC C04B 28/14; C04B 24/2623; C04B 2111/0062; B32B 13/08; C04B 24/383

(57) ABSTRACT

Disclosed is gypsum board with good strength, as well as gypsum slurries, methods, and cover sheets. Board is formed using one or more of starch, electrolyte, and/or hydrophilic material. These strength ingredients can be applied onto a cover sheet before contacting a gypsum slurry used in forming a gypsum layer in the board, and/or can be incorporated into the gypsum slurry used for forming one or more gypsum layers in the board, e.g., the board core and/or a concentrated gypsum layer between the core and one or both cover sheets.

### CROSS-REFERENCE TO RELATED APPLICATIONS

This patent application claims the benefit of U.S. Provisional Patent Application No. 62/550,373, filed Aug. 25, 2017, which is incorporated by reference.

### BACKGROUND OF THE INVENTION

Set gypsum is a well-known material that is used in many products, including panels and other products for building construction and remodeling. One such panel (often referred to as gypsum board) is in the form of a set gypsum core sandwiched between two cover sheets (e.g., paper-faced board) and is commonly used in drywall construction of interior walls and ceilings of buildings. One or more dense layers, often referred to as “skim coats” may be included on either side of the core, usually at the paper-core interface.

Gypsum (calcium sulfate dihydrate) is naturally occurring and can be mined in rock form. It can also be in synthetic form (referred to as “syngyp” in the art) as a by-product of industrial processes such as flue gas desulfurization. From either source (natural or synthetic), gypsum can be calcined at high temperature to form stucco (i.e., calcined gypsum in the form of calcium sulfate hemihydrate and/or calcium sulfate anhydrite) and then rehydrated to form set gypsum in a desired shape (e.g., as a board). During manufacture of the board, the stucco, water, and other ingredients as appropriate are mixed, typically in a pin mixer as the term is used in the art. A slurry is formed and discharged from the mixer onto a moving conveyor carrying a cover sheet with one of the skim coats (if present) already applied (often upstream of the mixer). The slurry is spread over the paper (with skim coat optionally included on the paper). Another cover sheet, with or without skim coat, is applied onto the slurry to form the sandwich structure of desired thickness with the aid of, e.g., a forming plate or the like. The mixture is cast and allowed to harden to form set (i.e., rehydrated) gypsum by reaction of the calcined gypsum with water to form a matrix of crystalline hydrated gypsum (i.e., calcium sulfate dihydrate). It is the desired hydration of the calcined gypsum that enables the formation of the interlocking matrix of set gypsum crystals, thereby imparting strength to the gypsum structure in the product. Heat is required (e.g., in a kiln) to drive off the remaining free (i.e., unreacted) water to yield a dry product.

Reducing the density of the board is of significant interest as long as sufficient strength is maintained. To reduce weight, mass can be removed from the volume of the board and replaced with, e.g., voids, such as air voids created from foam as well as water voids caused by evaporation of water in excess of the amount needed for the rehydration of stucco to gypsum. Perlite and other lightweight filler can also be used as an alternative or supplement to the air and water voids. Lower weight board is easier to handle, transport, and install, allowing for desired efficiencies in the installation of the board. While lighter weight board is desired, it should not be at the expense of achieving board strength desired by consumers. As mass is removed from the board, it is a challenge to maintain sufficient strength and integrity in the board.

It will be appreciated that this background description has been created by the inventors to aid the reader, and is not to be taken as a reference to prior art nor as an indication that any of the indicated problems were themselves appreciated in the art. While the described principles can, in some regards and embodiments, alleviate the problems inherent in other systems, it will be appreciated that the scope of the protected innovation is defined by the attached claims, and not by the ability of the claimed invention to solve any specific problem noted herein.

### BRIEF SUMMARY OF THE INVENTION

The invention relates to gypsum board with enhanced strength, which can be particularly useful for producing lightweight gypsum board, e.g., having a board density of about 35 pcf or less, or lower. The invention provides methods of producing board, gypsum slurries, gypsum board, and cover sheets that take a novel approach using particular strength additives, thereby addressing the challenge of maintaining good strength in the board even as mass is removed from the board and replaced with voids. The strength additives involve one or more of starch, electrolyte, and hydrophilic material, where these additives are provided on an inner surface of a cover sheet, and/or in a gypsum slurry used for forming one or more gypsum layers in the board, e.g., the board core and/or in an optional concentrated layer.

Thus, in one aspect, the invention provides a method of preparing gypsum board. The method comprises providing a first cover sheet. One or more of the following ingredients are applied to an inner surface of the first cover sheet: starch, an electrolyte, and a hydrophilic material. These ingredients can be applied to the inside surface of the cover sheet individually or as part of one or more compositions containing any desired combination of the ingredients. A slurry, comprising at least stucco and water, is mixed, e.g., in a pin or pinless mixer. The slurry is disposed between the first cover sheet and a second cover sheet to form an assembly, such that the slurry faces the inner surface of the cover sheet. The assembly is cut into a board and the board is dried. The board that is produced can be made at low densities while maintaining good strength in the board.

In another aspect, the invention provides a gypsum slurry (sometimes referred to as a stucco slurry). The slurry comprises stucco, water, and ingredients comprising starch and at least one of the following: an electrolyte, and/or a hydrophilic material. When the slurry is used to make a gypsum core disposed between two cover sheets in a board having a density of about 35 pounds per cubic foot (560 kg/m3) or less, the board has a nail pull resistance of at least about 65 lbs-f according to ASTM 473-10, method B.

In another aspect, the invention provides a gypsum board. The board includes a board core comprising set gypsum formed from a first slurry comprising water, stucco, and optionally, one or more of the following ingredients: starch, an electrolyte, and a hydrophilic material. The core defines a first core face. A concentrated layer is formed from a second slurry comprising at least stucco, water, and one or more of the following ingredients: starch, an electrolyte, and a hydrophilic material. The concentrated layer is disposed in bonding relation to the first core face. In some embodiments where one or more of the starch, electrolyte, and hydrophilic material is included in forming the board core, the starch, electrolyte, and/or hydrophilic material is included in a higher concentration in forming the concentrated layer than in forming the board core. The board core preferably has a thickness greater than the thickness of the concentrated layer. Optionally, the board exhibits one or more of the following: (a) the concentrated layer has an average core hardness that is at least about 1.5 times greater than the average core hardness of the board core; (b) when one or more of the starch, electrolyte, and hydrophilic material is present in forming the core, the concentrated layer is formed from at least about 1.2 times the starch, electrolyte, and hydrophilic material used in forming the board core; (c) the board core has a dry density of about 30 pcf or less; (d) the concentrated layer has a dry density of at least about 1.1 times higher than the dry density of the board core; and (e) the first slurry has a first water-stucco ratio and the second slurry has a second water-stucco ratio, such that the second water-stucco ratio is at least about 1.2 times higher than the first water-stucco ratio.

In another aspect, the invention provides another gypsum board. The board comprises a set gypsum core disposed between two cover sheets. The core is formed from a slurry comprising stucco, water, and at least one of starch, electrolyte, and hydrophilic material. The board has a density of about 35 pounds per cubic foot (560 kg/m3) or less, and a nail pull resistance of at least about 65 lbs-f according to ASTM 473-10, method B.

In another aspect, the invention provides another gypsum board. The board comprises a set gypsum core disposed between two cover sheets. The core is formed from a slurry comprising stucco and water. At least one cover sheet contains at least one or more of the following ingredients on an inner surface of the cover sheet: starch, an electrolyte, and a hydrophilic material.

In another aspect, the invention provides a cover sheet. The cover sheet has a major inner surface and a major outer surface. The major inner surface contains one or more of the following ingredients thereon: starch, an electrolyte, and a hydrophilic material.

### BRIEF DESCRIPTION OF DRAWING(S)

FIG. 1A is a schematic illustration of a cross-section of a gypsum board, showing additives on an inner surface of a face cover sheet of the board.

FIG. 1B is a schematic illustration of a cross-section of a gypsum board, showing additives in a gypsum core of the board between two cover sheets.

FIG. 1C is a schematic illustration of a cross-section of a gypsum board, showing additives in a concentrated gypsum layer between a gypsum core and one of the cover sheets.

FIG. 2 is a graph illustrating nail pull resistance measurements shown in two boards containing additives on an inner surface of a cover sheet in comparison with a control board absent such additives on the cover sheet, as described in Example 1.

### DETAILED DESCRIPTION OF THE INVENTION

Embodiments of the present invention are premised, at least in part, on using certain strength ingredients in gypsum product. “Strength ingredients” as discussed herein refer to one or more of starch, electrolyte and hydrophilic material as described herein. These strength ingredients can be applied on an inner surface of a cover sheet (e.g., made of paper, mat, or the like) in accordance with some embodiments. The inner surface of the cover sheet faces the inside of the board, i.e., toward a board core or other gypsum layer. In other embodiments, the strength additives can be included in gypsum slurry used for forming a gypsum layer, e.g., the board core and/or an optional concentrated layer disposed between the core and cover sheet, as desired. If desired, the strength ingredients can be provided both on the cover sheet and in the slurry for forming one or more of the gypsum layer(s). Accordingly, the invention provides a method of producing board, gypsum slurry, gypsum board, and cover sheet.

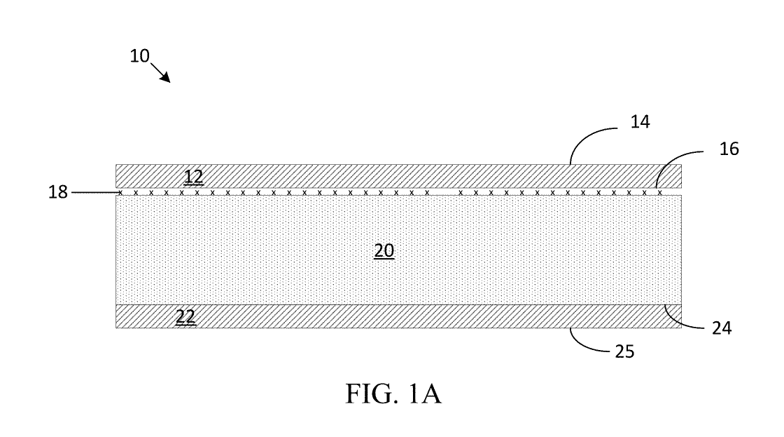

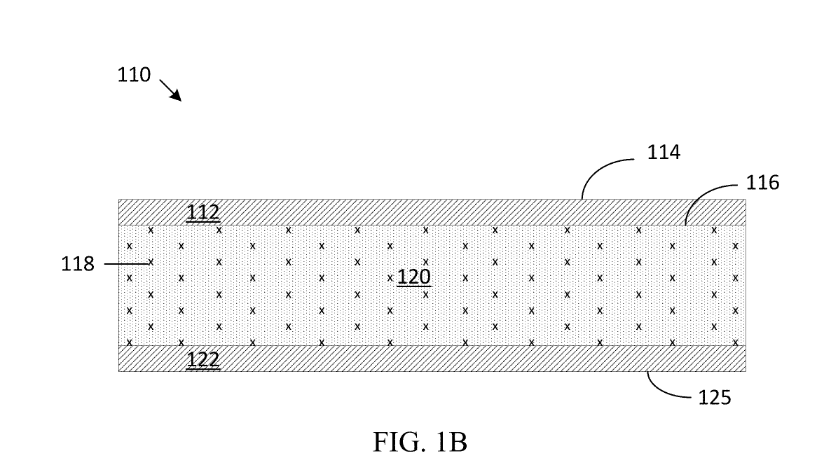

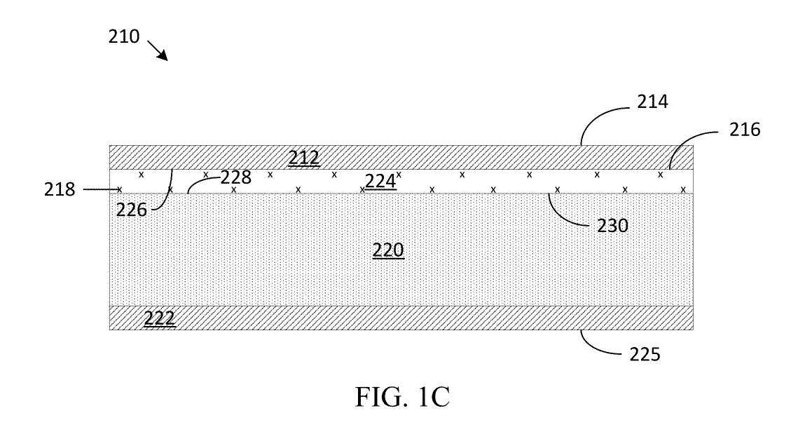

FIGS. 1A-1C are cross-sectional schematic views showing examples of different board arrangements with strength ingredient in the form of at least one of starch, electrolyte, and hydrophilic additive. The board 10, 100, or 200 includes a first cover sheet (generally the “face” paper) 12, 112, or 212 having an outer surface 14, 114, or 214 and an inner surface 16, 116, or 216. The inner surface 16, 116, or 216 faces a board core 20, 120, or 220, which is formed from a gypsum slurry comprising stucco, water, the strength ingredient(s), and other desired additives including foam (prepared from foaming agent), dispersant, polyphosphate, migrating starch, retarder, accelerator, etc. A second cover sheet 22, 122, or 222 (generally the “back” paper) forms the back surface of the board as known in the art. In use, normally the board 10, 100, 200 is installed such that an outside surface 25, 125, 225 of the back paper 22, 122, or 222 faces the studs, joists, or the like of a construction assembly, whereas the opposite side, i.e., the face cover sheet 12, 112, 212 normally is the face of the board. The cover sheets can be made of any suitable material, such as paper or a mat as known in the art.

Strength ingredients as described herein can be included in one or more of the locations shown in the arrangements of FIGS. 1A-1C. For example, as seen in FIG. 1A, the strength ingredient 18, which is in the form of at least one of starch, electrolyte, and hydrophilic additive, can be included on the inner surface 16 of the face paper 12. If desired, the strength ingredient 18 could optionally be included on an inner surface 24 of the back paper 22 in addition to, or as an alternative to, the inner surface 16 of the face paper 12. The strength ingredient 18 can be applied in any suitable manner, e.g., by way of spraying, various coating techniques (e.g., rolling or flood-coating), etc., and other such known techniques. The applied strength additives can be wet or optionally dried before contacting gypsum slurry during the board manufacturing process. While not wishing to be bound by any particular theory, it is believed that the placement of the strength ingredients on the inner surface 16 of the face paper 12 provides strength because of, e.g., the formation of hydrogen bonds between cover sheet-strength ingredient and/or gypsum-strength ingredient.

FIG. 1B illustrates embodiments where the strength ingredient 118, which is in the form of one or more non-migrating starch and one or more of electrolyte and/or hydrophilic material, is included in the gypsum slurry used in forming the board core 120. If desired, a skim coat (not shown) as known in the art or concentrated layer discussed herein can optionally be included between core 120 and face paper 112.

FIG. 1C shows a concentrated layer 224 between the first cover sheet 212 and the core 220, where the concentrated layer 224 is formed from a gypsum slurry containing strength ingredient 218, which is in the form of one or more non-migrating starch and one or more of electrolyte or hydrophilic material. The concentrated layer 224 can include features as described in commonly assigned, co-pending U.S. patent application Ser. Nos. 15/186,176; 15/186,212; 15/186,232; and Ser. No. 15/186,257, which concentrated layer arrangements are incorporated herein by reference. As seen in FIG. 1C, the concentrated layer has a first surface 226 that faces the inner surface 216 of paper 212, and a second surface 228 that faces the board core 220. If desired, a concentrated layer (formed from a gypsum slurry with or without strength ingredient as described herein) can be disposed on the other side of the core, i.e., between the core 220 and back paper 222 in addition to, or as an alternative to the location of the layer 224 between the face paper 212 and core 220.

The starch is generally a non-migrating starch. In this respect, migratory acid-modified starches are different and known in the art as having smaller molecular chains. These smaller chained migratory starches can generally migrate within a gypsum slurry toward the cover sheet and enhance cover sheet-gypsum layer bond but are not beneficial for enhancing board strength. The acid-modified migratory starches have minimal molecular weight, typically below about 6,000 Daltons. Preferred starches in accordance with embodiments of the invention have higher molecular weights than migratory starches, e.g., at least about 15,000 Daltons, at least about 30,000 Daltons, etc. The average molecular weight is indicated by the peak viscosity. In accordance with embodiments of the invention, a non-migratory starch is used in the strength ingredients defined herein, although migratory starch can also be used in the gypsum slurry if desired, for cover sheet-gypsum layer bond enhancement.

The strengthening starch of preferred embodiments can be a pregelatinized (cooked) starch and/or uncooked starch. In this regard, starches are classified as carbohydrates and contain two types of polysaccharides, namely linear amylose, and branched amylopectin. Starch granules are semi-crystalline, e.g., as seen under polarized light, and are insoluble at room temperatures. Uncooked starches are characterized as being cold water insoluble and having a semi-crystalline structure. Typically, uncooked starches are obtained by wet milling and are not modified by heating wet starch as in the case of cooked starches. Pregelatinized, or cooked, starches are characterized by being cold water soluble and having a non-crystalline structure.

Cooked starches can be prepared by heating wet starch, and can be prepared, e.g., by extrusion techniques. See, e.g., co-pending U.S. patent application Ser. Nos. 14/494,547; 14/044,582; and Ser. No. 13/835,002. Cooked starches are referred to as pregelatinized starches since the crystalline structure of the starch granules melts, and results in starch gelatinization, which is characterized by the disappearance of the birefringence under a microscope with a polarized light. Gelatinization is the process in which the starch is placed in water and heated (“cooked”) such that the crystalline structure of the starch granules is melted and the starch molecules dissolve in water such that a good dispersion results. It has been found that, when transforming a starch granule to gelatinized form, initially the starch granule provides little viscosity in water because starch granules are water insoluble. As the temperature increases, the starch granule swells and the crystalline structure melts at the gelatinization temperature. The peak viscosity is when the starch granule has maximum swelling. Further heating will break the starch granules and dissolve the starch molecules in water, with a precipitous reduction in viscosity. After cooling, the starch molecule will reassociate to form a 3-D gel structure, with the viscosity increasing due to the gel structure.

Examples of suitable starches include, but are not limited to, one or more of native cereal starches, native root starches, native tuber starches, and/or chemically modified starches, with specific representative examples including, e.g., corn starch (normal, waxy, and/or high-amylose), A type wheat starch, B type wheat starch, pea starch, substituted starches having substituted groups (such as acetate, phosphate, hydroxyethyl, hydroxypropyl) on starch hydroxyl groups, or any combination thereof.

Starch, whether uncooked and/or cooked, can have any suitable viscosity. In some embodiments, one or more of a pregelatinized starch having a mid-range viscosity of from about 20 centipoise to about 700 centipoise (as measured according to the VMA method) or an uncooked starch of peak viscosity from about 100 Brabender Units to about 900 Brabender Units, as measured according to the methodology described herein, can be used. The viscosity characteristic is determined as the starch is placed under certain conditions according to the respective viscosity measurement methodologies described herein, but it will be understood that the starch need not be incorporated into the gypsum board under these conditions.

To reduce peak viscosities of uncooked or cooked starch, in accordance with some embodiments of the invention, the starch molecule can be modified, e.g., to hydrolyze glycosidic bonds between glucose units to achieve desired molecular weight. For example, such modifications can include acid modifications, enzyme modifications, and/or other methods. The most commonly used starch converting enzyme is α-amylase (alpha-amylase). The enzyme hydrolysis reaction can be stopped either by adjusting the pH or by heating. To prepare acid-modified starches, it will be appreciated that aqueous suspension of unmodified starch can be treated with, e.g., a small quantity of acid, e.g., a strong acid such as hydrochloric acid, sulfuric acid, nitric acid, hydrofluoric acid, or the like. By adjusting reaction time, the degree of depolymerization can be modified. For example, when the proper fluidity is achieved, e.g., as determined by in-process laboratory controls, mild alkali is introduced to neutralize the acid and stop hydrolysis. Thus, acid-modified starches can be prepared in various fluidities. Also, acid-modified starches may be used directly after neutralization without further purification or may be purified to remove salts. The end use of the acid-modified starch may determine the desirability of purification. For example, a composition of starch modified by sulfuric acid and neutralized by calcium hydroxide may contain sulfate and calcium ions which could be added to a stucco and water slurry. In embodiments where the starch is used in a gypsum slurry (e.g., as in FIGS. 1B-1C), since the stucco has sulfate and calcium ions already, it may not be necessary to purify the sulfuric acid-modified starch prior to addition to the slurry. Thus, considerations to determine the desirability of purification include, for example, the identity of the acid and alkali base and whether it is desirable to add other ions besides sulfate or calcium ions to the slurry.

Referring to uncooked starch, in some embodiments, uncooked starch has a higher bulk density with less variability than found in pregelatinized starch. This is useful because, for example, consistent density allows a volumetric feeder to add starch more accurately and consistently. For example, in some embodiments the bulk density can be from about 35 pcf to about 50 pcf, from about 35 pcf to about 45 pcf, from about 37 pcf to about 50 pcf, from about 37 pcf to about 45 pcf, from about 40 pcf to about 50 pcf, from about 40 pcf to about 47 pcf, from about 40 pcf to about 45 pcf, from about 41 pcf to about 45 pcf, etc.

The uncooked starches according to some embodiments of the invention typically are in native, granular form. Peak viscosity of uncooked starches in accordance with some embodiments of the invention relates to average molecular weight of starch. In accordance with some embodiments of the invention, the granular uncooked form can undergo at least some degree of gelatinization during gypsum wallboard manufacture (e.g., in the kiln).

In some embodiments where uncooked starch is used, the uncooked starch can have a mid-range molecular weight, indicated by a peak viscosity from 100 BU to 900 BU. The mid-range viscosity of the uncooked starch is determined according to the following method. The Brabender peak viscosity is measured using a Viscograph-E (C.W. Brabender) set to 75 rpm; 700 cmg. The starch is in a slurry having a concentration of 15% solids in water. The starch slurry is heated from 25° C. to 95° C. at a rate of 3° C./min. It is then held at 95° C. for 10 min until being cooled 50° C. at a rate of −3° C./min.

In various embodiments, the mid-range peak viscosity of the uncooked starch can be from about 100 Brabender Units to about 850 Brabender Units, from about 100 Brabender Units to about 700 Brabender Units, from about 100 Brabender Units to about 550 Brabender Units, from about 100 Brabender Units to about 460 Brabender Units, from about 100 Brabender Units to about 300 Brabender Units, from about 120 Brabender Units to about 875 Brabender Units, from about 150 Brabender Units to about 900 Brabender Units, from about 150 Brabender Units to about 850 Brabender Units, from about 150 Brabender Units to about 750 Brabender Units, from about 150 Brabender Units to about 500 Brabender Units, from about 150 Brabender Units to about 300 Brabender Units, from about 250 Brabender Units to about 850 Brabender Units, from about 250 Brabender Units to about 600 Brabender Units, from about 250 Brabender Units to about 500 Brabender Units, from about 350 Brabender Units to about 800 Brabender Units, from about 350 Brabender Units to about 750 Brabender Units, from about 400 Brabender Units to about 900 Brabender Units, from about 400 Brabender Units to about 700 Brabender Units, from about 500 Brabender Units to about 850 Brabender Units, from about 500 Brabender Units to about 700 Brabender Units, from about 600 Brabender Units to about 900 Brabender Units, etc.

Properties of uncooked starches include having low viscosity in cold water (i.e., at a temperature of 77° F. (25° C.)), in contrast with properties of pregelatinized starches, include having instant high viscosity in cold water. Uncooked starches according to embodiments of the invention can have any suitable cold-water viscosity. In some embodiments, the cold-water viscosity is from about 1 centipoise to about 500 centipoise, e.g. from about 1 centipoise to about 400 centipoise, from about 1 centipoise to about 300 centipoise, from about 1 centipoise to about 200 centipoise, or from about 1 centipoise to about 100 centipoise. In some embodiments, uncooked starch can have a cold-water viscosity of about less than 50 centipoise, e.g., about 40 centipoise or less, about 30 centipoise or less, about 20 centipoise or less, or about 10 centipoise or less in cold water (e.g., from about 1 centipoise to about 50 centipoise, from about 1 centipoise to about 40 centipoise, from about 1 centipoise to about 30 centipoise, from about 1 centipoise to about 20 centipoise, from about 1 centipoise to about 10 centipoise, from about 5 centipoise to about 50 centipoise, from about 5 centipoise to about 30 centipoise, from about 5 centipoise to about 20 centipoise, from about 3 centipoise to about 15 centipoise, from about 3 centipoise to about 10 centipoise, from about 3 centipoise to about 7 centipoise, etc.).

The cold-water viscosity is measured according to a Brookfield viscometer method with a testing profile as follows. Starch (20 g, dry) is added into water (180 g) in a Waring blender (model 31BL92) while mixing at low speed for 15 seconds. Starch solution (200 g) is transferred into a measuring cup. No. 2 paddle and 60 RPM are selected. The viscosity value measured at 20 seconds is used as the viscosity of the starch.

As used herein, uncooked means that the starch has a degree of gelatinization of less than about 5% (e.g., less than about 3%, or less than about 1%, such as zero) before being included in the gypsum slurry. In some embodiments, the uncooked starch can be partially or fully gelatinized when exposed to elevated temperature in the gypsum wallboard manufacturing process, e.g., in the kiln for the drying step to remove excess water.

Referring now to cooked (pregelatinized) starches, the cooked starch can be prepared in any suitable manner, e.g., in an extruder as described in U.S. Pat. Pub. 2015/0010767. The cooked starch can be prepared to have any desired properties (e.g. viscosity, cold water solubility, cold-water viscosity, etc.).

Pregelatinized starch can have any suitable viscosity. In some embodiments, the viscosity of the pregelatinized starch is characterized as having a “mid-range” viscosity (i.e., having a viscosity from about 20 centipoise to about 700 centipoise) when the pregelatinized starch is subjected to conditions according to the VMA method with the pregelatinized starch in water in an amount of 15% by weight of the total weight of the pregelatinized starch and water.

In some embodiments, the viscosity of the pregelatinized starch can be from about 20 centipoise to about 1,000, e.g. from about 20 centipoise to about 900 centipoise, from about 20 centipoise to about 800 centipoise, from about 20 centipoise to about 700 centipoise, from about 20 centipoise to about 500 centipoise, from about 30 centipoise to about 200 centipoise, or from about 100 centipoise to about 700 centipoise. Examples include, but are not limited to, pregelatinized corn starches, e.g., having a viscosity of about 773 centipoise or 100 centipoise, respectively, according to the VMA method as set forth in U. S. Patent Application Publication 2012/0113124.

In some embodiments, the pregelatinized starch can be prepared to have desired cold water solubility. Conventional pregelatinization techniques involve making starch cold water soluble and generally require cooking starch in an excess amount of water. Extrusion allows for a combination of heating and mechanical shearing, and is an energy efficient method that can be used to produce pregelatinized starch in a one step process having a low moisture content with cold water solubility. Cold water solubility is defined as having any amount of solubility in water at room temperature (about 25° C.). In some embodiments, cold water soluble starches can have a cold water solubility greater than about 30% and can increase the strength of the gypsum board. The solubility of the pregelatinized starch in water is defined as the amount of starch that dissolves in room temperature water divided by the total amount of starch.

In some embodiments, the cold water solubility of the pregelatinized starch is from about 30% to about 100%. For example, the cold water solubility of the pregelatinized starch can be from about 50% to about 100%.

In some embodiments, the pregelatinized starch has a cold-water viscosity (10% solids, 25° C.) of from about 10 BU to about 120 BU, measured according to the Brabender method, e.g., from about 20 BU to about 110 BU, from about 30 BU to about 100 BU, from about 40 BU to about 90 BU, from about 50 BU to about 80 BU, or from about 60 BU to about 70 BU. According to the Brabender viscosity measurement procedure as referred to herein, viscosity is measured using a C.W. Brabender Viscograph, e.g., a Viscograph-E that uses reaction torque for dynamic measurement. It is to be noted that, as defined herein, the Brabender units are measured using a sample cup size of 16 fl. oz. (about 500 cc), with a 700 cmg cartridge at an RPM of 75. One of ordinary skill in the art also will readily recognize that the Brabender units can be converted to other viscosity measurements, such as centipoises (e.g., cP=BU×2.1, when the measuring cartridge is 700 cmg) or Krebs units, as described therein.

In some embodiments, a combination of uncooked and cooked starches is used, e.g., in arrangements of FIGS. 1A-1C. For example, the starches can be combined in a wet composition, e.g., slurry. Without wishing to be bound by any particular theory, it is believed that the uncooked starch can help modify the strength ingredient slurry's flowability, e.g., to facilitate ease of application to the inner surface of the face paper. The flowability can be measured, e.g., by a slump test as known in the art, and desirably, the composition containing the strength ingredients (to be sprayed, coated, or otherwise applied to the cover sheet) provides flowability effective to allow application of the strength ingredient slurry. The wet composition (e.g., slurry) containing the strength ingredient(s) can have any suitable flowablity. Preferably, in some embodiments, the flowability can be associated with its viscosity, for example, from about 50 cps to about 2000 cps, e.g., from about 200 cps to about 1500 cps, as measured according to the Brookfield viscometer test at 60 rpm with No. 5 Spindle.

The combination of starches may be pre-mixed (e.g., in a dry mix, optionally with other components such as stucco, etc., or in a wet mix with other wet ingredients), or they can be included into board production one at a time, or any variation thereof. Any suitable proportion of uncooked starch to pregelatinized starch may be included, e.g., 0:100 to 100:0 (since the combination is optional), or 1:100 to 100:1. In some embodiments, the ratio of uncooked to pregelatinized starch is from about 90:10 to about 10:90, from about 80:20 to about 20:80, from about 70:30 to about 30:70, from about 60:40 to about 40:60, from about 90:10 to about 60:40, from about 90:10 to about 70:30, from about 90:10 to about 80:20, from about 80:20 to about 60:40, or from about 80:20 to about 70:30, etc. In exemplary embodiments, the ratio of uncooked starch to pregelatinized starch can be about 25:75, about 30:70, about 35:65, about 50:50, about 65:35, about 70:30, about 75:25, etc.

The starch can be used in any suitable amount. For example, when applied to the cover sheet, the starch can be included, for example, in an amount from about 0.1 lbs/MSF to about 35 lbs/MSF, such as from about 2 lbs/MSF to about 35 lbs/MSF, or from about 6 lbs/MSF to about 20 lbs/MSF, of the cover sheet. When included in a gypsum slurry, the starch can be included, for example, in an amount from about 0.1% to about 20% by weight of the stucco, such as from about 0.5% to about 10% by weight of the stucco.

In some embodiments, the strength ingredients include at least one electrolyte. Without wishing to be bound by any particular theory, it is believed that the electrolyte is a catalyst for hydration of the starch, particularly in embodiments using uncooked starch. It is further believed that desired electrolytes facilitate the speed of hydration of the starch and strength of dried starch, e.g., as applied to the cover sheet. Any suitable electrolyte can be used. In some embodiments, the electrolyte is in salt form. For example, in some embodiments the electrolyte includes magnesium nitrate hexahydrate, sodium chloride, calcium nitrate, magnesium chloride, calcium nitrite, magnesium nitrite, or any combination thereof. In some embodiments, the electrolyte comprises magnesium nitrate hexahydrate.

The electrolyte can be used in any suitable amount. For example, when applied to the cover sheet, the electrolyte can be included, for example, in an amount from about 0.1 lbs/MSF to about 35 lbs/MSF, such as from about 2 lbs/MSF to about 35 lbs/MSF, or from about 0.1 lbs/MSF to about 0.5 lbs/MSF, of the cover sheet. When included in a gypsum slurry, the electrolyte can be included, for example, in an amount from about 0.1% to about 1% by weight of the stucco, such as from about 0.1% to about 0.5% by weight of the stucco.

When used in the strength ingredients, any suitable hydrophilic material can be used. In some embodiments, the hydrophilic material can include cellulosic material and/or hydrophilic polymer. Without wishing to be bound by any particular theory, it is believed that the hydrophilic polymer or other hydrophilic material desirably can form hydrogen bonds with substrates such as starch and/or cover sheet (e.g., paper). This is surprisingly beneficial because it will enhance the strength of the surface of the cover sheet (e.g., paper). The hydrophilic polymer or other hydrophilic material can have any suitable melting point, and desirably has a melting point below the operating temperature in a kiln used in gypsum wallboard manufacture, e.g., preferably a melting point of about 220° C. or less. This is desirable to avoid calcination of the gypsum crystals. For example, in some embodiments, the melting point of the hydrophilic material can be from about 120° C. to about 220° C., such as from about 150° C. to about 200° C., from about 160° C. to about 190° C., or from about 170° C. to about 190° C. (e.g., about 180° C.).

For example, the hydrophilic material can include a cellulosic material having a molecular weight from about 1,000 Daltons to about 100,000 Daltons, such as from about from about 1,000 Daltons to about 75,000 Daltons, from about 1,000 Daltons to about 50,000 Daltons, from about 1,000 Daltons to about 25,000 Daltons, from about 1,000 Daltons to about 10,000 Daltons, from about 3,000 Daltons to about 25,000 Daltons, from about 3,000 Daltons to about 10,000 Daltons, from about 3,000 Daltons to about 10,000 Daltons, from about 3,000 Daltons to about 5,000 Daltons, etc. The cellulosic material can be one or more of commercially available thickening agents for adjusting viscosity of starch slurry to desired viscosity. Examples of cellulosic materials include, but are not limited to cellulose acetate, cellulose triacetate, cellulose propionate, cellulose acetate butyrate, nitrocellulose and cellulose, or any combination thereof.

In some embodiments, the hydrophilic polymer comprises polyvinyl alcohol. In some embodiments, the polyvinyl alcohol has a molecular weight from about 20,000 Daltons to about 30,000 Daltons. Other suitable hydrophilic polymers include hyaluronic acid, gellan gum, xanthan gum and any soluble polyelectrolyte or any combination thereof.

Any suitable amount of hydrophilic material can be used. If included on the cover sheet, the hydrophilic material can be included, for example, in an amount from about 0.1 lbs/MSF to about 35 lbs/MSF, such as from about 2 lbs/MSF to about 35 lbs/MSF or from about 0.1 lbs/MSF to about 0.5 lbs/MSF, of the cover sheet. When included in a gypsum slurry, the hydrophilic material can be included, for example, in an amount from about 0.1% to about 5% by weight of the stucco, such as from about 0.1% to about 1% by weight of the stucco.

Turning now to the gypsum slurry, it is normally formed inside a pin or pinless main mixer during the manufacturing process. The slurry is formulated to include water, stucco, foaming agent (sometimes referred to simply as “foam”), and other additives as desired. In some embodiments, the strength ingredients of the invention can be included in the gypsum slurry as described herein. Multiple gypsum layers formed from separate gypsum slurries can be used as in embodiments containing a concentrated layer. The stucco can be in the form of calcium sulfate alpha hemihydrate, calcium sulfate beta hemihydrate, and/or calcium sulfate anhydrite. The stucco can be fibrous or non-fibrous. Foaming agent can be included to form an air void distribution within the continuous crystalline matrix of set gypsum.

The mode of introduction of additives into the mixer may vary. For example, various combinations of components may be pre-mixed before entering the mixer, e.g., one or more dry additives and/or one or more wet additives may be pre-mixed. By “added to the slurry,” as used herein, it will be understood that ingredients may be pre-mixed in any suitable manner prior to entry into the mixer where the gypsum slurry (sometimes called “stucco slurry”) is formed as set forth herein. The additives can be included in the gypsum slurry in a wet or dry form. If in a wet form, the additives can be included in any suitable concentration, and could be pre-mixed with other wet additives.

In some embodiments, the foaming agent comprises a major weight portion of unstable component, and a minor weight portion of stable component (e.g., where unstable and blend of stable/unstable are combined). The weight ratio of unstable component to stable component is effective to form an air void distribution within the set gypsum core. See, e.g., U.S. Pat. Nos. 5,643,510; 6,342,284; and 6,632,550. It has been found that suitable void distribution and wall thickness (independently) can be effective to enhance strength, especially in lower density board (e.g., below about 35 pcf). See, e.g., US 2007/0048490 and US 2008/0090068. Evaporative water voids, generally having voids of about 5 μm or less in diameter, also contribute to the total void distribution along with the aforementioned air (foam) voids. In some embodiments, the volume ratio of voids with a pore size greater than about 5 microns to the voids with a pore size of about 5 microns or less, is from about 0.5:1 to about 9:1, such as, for example, about 0.7:1 to about 9:1, about 0.8:1 to about 9:1, about 1.4:1 to about 9:1, about 1.8:1 to about 9:1, about 2.3:1 to about 9:1, about 0.7:1 to about 6:1, about 1.4:1 to about 6:1, about 1.8:1 to about 6:1, about 0.7:1 to about 4:1, about 1.4:1 to about 4:1, about 1.8:1 to about 4:1, about 0.5:1 to about 2.3:1, about 0.7:1 to about 2.3:1, about 0.8:1 to about 2.3:1, about 1.4:1 to about 2.3:1, about 1.8:1 to about 2.3:1, etc. In some embodiments, the foaming agent is present in the slurry, e.g., in an amount of less than about 0.5% by weight of the stucco such as about 0.01% to about 0.5%, about 0.01% to about 0.4%, about 0.01% to about 0.3%, about 0.01% to about 0.2%, about 0.01% to about 0.1%, about 0.02% to about 0.4%, about 0.02% to about 0.3%, about 0.02% to about 0.2%, etc.

Additives such as accelerator (e.g., wet gypsum accelerator, heat resistant accelerator, climate stabilized accelerator) and retarder are well known and can be included in the gypsum slurry, if desired. See, e.g., U.S. Pat. Nos. 3,573,947 and 6,409,825. In some embodiments where accelerator and/or retarder are included, the accelerator and/or retarder each can be in the gypsum slurry in an amount on a solid basis of, e.g., from about 0% to about 10% by weight of the stucco (e.g., about 0.1% to about 10%), such as, for example, from about 0% to about 5% by weight of the stucco (e.g., about 0.1% to about 5%). Other additives as desired may be included, e.g., to impart strength to enable lower weight product with sufficient strength, to avoid permanent deformation, to promote green strength, e.g., as the product is setting on the conveyor traveling down a manufacturing line, to promote fire resistance, to promote water resistance, etc.

For example, the slurry can optionally include at least one dispersant to enhance fluidity in some embodiments. Like other ingredients, the dispersants may be included in a dry form with other dry ingredients and/or in a liquid form with other liquid ingredients in the core slurry. Examples of dispersants include naphthalenesulfonates, such as polynaphthalenesulfonic acid and its salts (polynaphthalenesulfonates) and derivatives, which are condensation products of naphthalenesulfonic acids and formaldehyde; as well as polycarboxylate dispersants, such as polycarboxylic ethers, for example, PCE211, PCE111, 1641, 1641F, or PCE 2641-Type Dispersants, e.g., MELFLUX 2641F, MELFLUX 2651F, MELFLUX 1641F, MELFLUX 2500L dispersants (BASF), and COATEX Ethacryl M, available from Coatex, Inc.; and/or lignosulfonates or sulfonated lignin. Lignosulfonates are water-soluble anionic polyelectrolyte polymers, byproducts from the production of wood pulp using sulfite pulping. One example of a lignin useful in the practice of principles of embodiments of the present invention is Marasperse C-21 available from Reed Lignin Inc.

Lower molecular weight dispersants are generally preferred. Lower molecular weight naphthalenesulfonate dispersants are favored because they trend to a lower water demand than the higher viscosity, higher molecular weight dispersants. Thus, molecular weights from about 3,000 to about 10,000 (e.g., about 8,000 to about 10,000) are preferred. As another illustration, for PCE211 type dispersants, in some embodiments, the molecular weight can be from about 20,000 to about 60,000, which exhibit less retardation than dispersants having molecular weight above 60,000.

One example of a naphthalenesulfonate is DILOFLO, available from GEO Specialty Chemicals. DILOFLO is a 45% naphthalenesulfonate solution in water, although other aqueous solutions, for example, in the range of about 35% to about 55% by weight solids content, are also readily available. Naphthalenesulfonates can be used in dry solid or powder form, such as LOMAR D, available from GEO Specialty Chemicals, for example. Another exemplary naphthalenesulfonate is DAXAD, available from Hampshire Chemical Corp.

If included, the dispersant can be included in any suitable (solids/solids) amount, such as, for example, about 0.1% to about 5% by weight of the stucco, e.g., about 0.1% to about 4%, about 0.1% to about 3%, about 0.2% to about 3%, about 0.5% to about 3%, about 0.5% to about 2.5%, about 0.5% to about 2%, about 0.5% to about 1.5%, etc.

One or more phosphate-containing compounds can also be optionally included in the slurry, if desired. For example, phosphate-containing components useful in some embodiments include water-soluble components and can be in the form of an ion, a salt, or an acid, namely, condensed phosphoric acids, each of which comprises two or more phosphoric acid units; salts or ions of condensed phosphates, each of which comprises two or more phosphate units; and monobasic salts or monovalent ions of orthophosphates as well as water-soluble acyclic polyphosphate salt. See, e.g., U.S. Pat. Nos. 6,342,284; 6,632,550; 6,815,049; and 6,822,033.

Phosphate-containing components in accordance with some embodiments of the invention can enhance green strength, resistance to permanent deformation (e.g., sag), dimensional stability, etc. Trimetaphosphate compounds can be used, including, for example, sodium trimetaphosphate, potassium trimetaphosphate, lithium trimetaphosphate, and ammonium trimetaphosphate. Sodium trimetaphosphate (STMP) is preferred, although other phosphates may be suitable, including for example sodium tetrametaphosphate, sodium hexametaphosphate having from about 6 to about 27 repeating phosphate units and having the molecular formula Naₙ₊₂PₙO₃ₙ₊₁ wherein n=6-27, tetrapotassium pyrophosphate having the molecular formula K₄P₂O₇, trisodium dipotassium tripolyphosphate having the molecular formula Na₃K₂P₃O₁₀, sodium tripolyphosphate having the molecular formula Na₅P₃O₁₀, tetrasodium pyrophosphate having the molecular formula Na₄P₂O₇, aluminum trimetaphosphate having the molecular formula Al(PO₃)₃, sodium acid pyrophosphate having the molecular formula Na₂H₂P₂O₇, ammonium polyphosphate having 1000-3000 repeating phosphate units and having the molecular formula (NH₄)ₙ₊₂PₙO₃ₙ₊₁ wherein n=1000-3000, or polyphosphoric acid having two or more repeating phosphoric acid units and having the molecular formula Hₙ₊₂PₙO₃ₙ₊₁ wherein n is two or more.

The phosphate can be included in a dry form or in a form in water (e.g., a phosphate solution from about 5% to about 20%, such as about a 10% solution). If included, the phosphate can be in any suitable amount (solids/solids basis), such as from about 0.01% to about 0.5% by weight of the stucco, e.g., from about 0.03% to about 0.4%, from about 0.1% to about 0.3%, or from about 0.12% to about 0.4% by weight of the stucco.

Suitable additives for fire-rated and/or water resistant product can also optionally be included, including e.g., siloxanes (water resistance); fiber; heat sink additives such as aluminum trihydrite (ATH), magnesium hydroxide or the like; and/or high expansion particles (e.g., expandable to about 300% or more of original volume when heated for about one hour at 1560° F.). See, e.g., co-pending, commonly assigned U.S. application Ser. No. 13/400,010 (filed Feb. 17, 2012) for description of these and other ingredients. In some embodiments, high expansion vermiculite is included, although other fire resistant materials can be included. The board of some fire-related product according to the invention can have a Thermal Insulation Index (TI) of about 17 minutes or greater, e.g., about 20 minutes or greater, about 30 minutes or greater, about 45 minutes or greater, about 60 minutes or greater, etc.; and/or a High Temperature Shrinkage (at temperatures of about 1560° F. (850° C.)) of less than about 10% in the x-y directions and expansion in the z-direction of at least about 2%, such as at least about 5%, at least about 10%, at least about 15%, or at least about 20%. The fire or water resistance additives can be included in any suitable amount as desired depending, e.g., on fire rating, etc. For example, if included, the fire or water resistance additives can be in an amount from about 0.5% to about 10% by weight of the stucco, such as from about 1% to about 10%, about 1% to about 8%, about 2% to about 10%, about 2% to about 8% by weight of the stucco, etc.

If included, the siloxane preferably is added in the form of an emulsion. The slurry is then shaped and dried under conditions which promote the polymerization of the siloxane to form a highly cross-linked silicone resin. A catalyst which promotes the polymerization of the siloxane to form a highly cross-linked silicone resin can be added to the gypsum slurry. In some embodiments, solventless methyl hydrogen siloxane fluid sold under the name SILRES BS 94 by Wacker-Chemie GmbH (Munich, Germany) can be used as the siloxane. This product is a siloxane fluid containing no water or solvents. It is contemplated that about 0.3% to about 1.0% of the BS 94 siloxane may be used in some embodiments, based on the weight of the dry ingredients. For example, in some embodiments, it is preferred to use from about 0.4% to about 0.8% of the siloxane based on the dry stucco weight.

The slurry formulation can be made with any suitable water/stucco ratio, e.g., about 0.4 to about 1.3. For example, in some embodiments, the water/stucco ratio can be from about 0.4 to about 1.2, about 0.4 to about 1.1, about 0.4 to about 1, about 0.4 to about 0.9, about 0.4 to about 0.85, about 0.45 to about 0.85, about 0.55 to about 0.85, about 0.55 to about 0.8, about 0.6 to about 0.9, about 0.6 to about 0.85, about 0.6 to about 0.8, etc.

The cover sheets can be formed of any suitable material and basis weight. Advantageously, board core formed from slurry comprising uncooked starch characterized by mid-range viscosity provides sufficient strength in board even with lower basis weight cover sheets such as, for example, less than 45 lbs/MSF (e.g., about 33 lbs/MSF to 45 lbs/MSF) even for lower weight board (e.g., having a density of about 35 pcf or below) in some embodiments. However, if desired, in some embodiments, heavier basis weights can be used, e.g., to further enhance nail pull resistance or to enhance handling, e.g., to facilitate desirable “feel” characteristics for end-users. In some embodiments, to enhance strength (e.g., nail pull strength), especially for lower density board, one or both of the cover sheets can be formed from paper and have a basis weight of, for example, at least about 45 lbs/MSF (e.g., from about 45 lbs/MSF to about 65 lbs/MSF, about 45 lbs/MSF to about 60 lbs/MSF, about 45 lbs/MSF to about 55 lbs/MSF, about 50 lbs/MSF to about 65 lbs/MSF, about 50 lbs/MSF to about 60 lbs/MSF, etc.). If desired, in some embodiments, one cover sheet (e.g., the “face” paper side when installed) can have aforementioned higher basis weight, e.g., to enhance nail pull resistance and handling, while the other cover sheet (e.g., the “back” sheet when the board is installed) can have somewhat lower weight basis if desired (e.g., weight basis of less than 45 lbs/MSF, e.g., from about 33 lbs/MSF to 45 lbs/MSF (e.g., about 33 lbs/MSF to about 40 lbs/MSF).

Board weight is a function of thickness. Since boards are commonly made at varying thickness, board density is used herein as a measure of board weight. The advantages of the strength ingredients in accordance with embodiments of the invention can be seen across various board densities, e.g., about 40 pcf or less, such as from about 10 pcf to about 40 pcf, from about 12 pcf to about 40 pcf, from about 16 pcf to about 35 pcf, from about 20 pcf to about 40 pcf, from about 24 pcf to about 37 pcf, etc. However, preferred embodiments of the invention have particular utility at lower densities where the enhanced strength provided by the strength ingredients of the invention advantageously enable the production of lower weight board with good strength and lower water demand than board made from other starches. For example, in some embodiments, board density can be, e.g. from about 12 pcf to about 35 pcf, from about 12 pcf to about 30 pcf, from about 12 pcf to about 27 pcf, from about 16 pcf to about 30 pcf, from about 16 pcf to about 27 pcf, from about 16 pcf to about 24 pcf, from about 18 pcf to about 30 pcf, from about 18 pcf to about 27 pcf, from about 20 pcf to about 30 pcf, from about 20 pcf to about 27 pcf, from about 24 pcf to about 35 pcf, from about 27 pcf to about 35 pcf, from about 27 pcf to about 34 pcf, from about 30 pcf to about 34 pcf, about 27 pcf to about 30 pcf, etc.

Thus, the strength ingredients of the invention provide strength enhancement to product according to the invention, which can be especially beneficial at lower weight/density. For example, in some embodiments, board according to the invention meets test protocols according to ASTM Standard C473-10, method B. For example, in some embodiments, when the board is cast at a thickness of ½ inch, the board has a nail pull resistance of at least about 65 lb as determined according to ASTM C 473-10, method B (e.g., at least about 68 lb, at least about 70 lb, at least about 72 lb, at least about 75 lb, at least about 77 lb, in each case with any suitable upper limit, such as 110 lb or higher, etc.). With respect to flexural strength, in some embodiments, when cast in a board of ½ inch thickness, the board has a flexural strength of at least about 36 lb in a machine direction (e.g., at least about 38 lb, at least about 40 lb, etc., in each case with any suitable upper limit, such as 80 lb or higher, etc.) and/or at least about 107 lb (e.g., at least about 110 lb, at least about 112 lb, etc., in each case with any suitable upper limit, such as 140 lb or higher, etc.) in a cross-machine direction as determined according to the ASTM standard C473. Due at least in part to the strength ingredient characteristic of embodiments of the invention, these standards can be met even with respect to lower density board (e.g., about 35 pcf or less) as described herein.

Product according to embodiments of the invention can be made on typical manufacturing lines. For example, board manufacturing techniques are described in, for example, U.S. Pat. No. 7,364,676 and U.S. Patent Application Publication 2010/0247937. Briefly, in the case of gypsum board, the process typically involves discharging a cover sheet onto a moving conveyor. Since gypsum board is normally formed “face down,” this cover sheet is the “face” cover sheet in such embodiments. In some embodiments, the strength ingredients can be pre-applied, or after the cover sheet is unwound on the board manufacturing line, the strength ingredients can be applied to the surface of the cover sheet using techniques described herein.

Dry and/or wet components of the gypsum slurry are fed to a mixer (e.g., pin mixer), where they are agitated to form the gypsum slurry. The mixer comprises a main body and a discharge conduit (e.g., a gate-canister-boot arrangement as known in the art, or an arrangement as described in U.S. Pat. Nos. 6,494,609 and 6,874,930). In some embodiments, the discharge conduit can include a slurry distributor with either a single feed inlet or multiple feed inlets, such as those described in U.S. Patent Application Publication 2012/0168527 A1 (application Ser. No. 13/341,016) and U.S. Patent Application Publication 2012/0170403 A1 (application Ser. No. 13/341,209), for example. In those embodiments, using a slurry distributor with multiple feed inlets, the discharge conduit can include a suitable flow splitter, such as those described in U.S. Patent Application Publication 2012/0170403 A1. Foaming agent can be added in the discharge conduit of the mixer (e.g., in the gate as described, for example, in U.S. Pat. Nos. 5,683,635 and 6,494,609) or in the main body if desired. Slurry discharged from the discharge conduit after all ingredients have been added, including foaming agent, is the primary gypsum slurry and will form the board core. This board core slurry is discharged onto the moving face cover sheet.

The face cover sheet may optionally be in bonding relation with a thin skim coat in the form of a relatively dense layer of slurry. Also, hard edges, as known in the art, can be formed, e.g., from the same slurry stream forming the face skim coat. In embodiments where foam is inserted into the discharge conduit, a stream of secondary gypsum slurry can be removed from the mixer body to form the dense skim coat slurry, which can then be used to form the face skim coat and hard edges as known in the art. If included, normally the face skim coat and hard edges are deposited onto the moving face cover sheet before the core slurry is deposited, usually upstream of the mixer. After being discharged from the discharge conduit, the core slurry is spread, as necessary, over the face cover sheet (optionally bearing skim coat) and covered with a second cover sheet (typically the “back” cover sheet) to form a wet assembly in the form of a sandwich structure that is a precursor to the final product. The second cover sheet may optionally bear a second skim coat, which can be formed from the same or different secondary (dense) gypsum slurry as for the face skim coat, if present. The cover sheets may be formed from paper, fibrous mat or other type of material (e.g., foil, plastic, glass mat, non-woven material such as blend of cellulosic and inorganic filler, etc.).

The wet assembly thereby provided is conveyed to a forming station where the product is sized to a desired thickness (e.g., via forming plate), and to one or more knife sections where it is cut to a desired length. The wet assembly is allowed to harden to form the interlocking crystalline matrix of set gypsum, and excess water is removed using a drying process (e.g., by transporting the assembly through a kiln). It also is common in the manufacture of gypsum board to use vibration in order to eliminate large voids or air pockets from the deposited slurry. Each of the above steps, as well as processes and equipment for performing such steps, are known in the art.

The strength ingredients of the invention can be used in formulating various products, such as, for example, gypsum wallboard, acoustical (e.g., ceiling) tile, gypsum-cellulosic fiber products, such as gypsum-wood fiber wallboard, and the like. In some embodiments, such product can be formed from slurry according to embodiments of the invention.

As such, the strength ingredients as described herein can have beneficial effect, as described herein, in product besides paper-faced gypsum board in embodiments of the invention. For example, the ingredients can be used in mat-faced products (e.g., woven) where board cover sheets are in the form of fibrous mats. The mats can optionally bear an additional finish (e.g., on an outer surface of the mat cover sheet) to reduce water permeability. Other ingredients that can be included in making such mat-faced product, as well as materials for the fibrous mats and methods of manufacture, are discussed in, e.g., U.S. Pat. No. 8,070,895, as well as U.S. Patent Application Publication 2009/0247937.

In addition, gypsum-cellulosic product can be in the form of cellulosic host particles (e.g., wood fibers), gypsum, strength ingredients as described herein, and other ingredients (e.g., water resistant additives such as siloxanes) as desired. Other ingredients and methods of manufacture are discussed in, e.g., U.S. Pat. Nos. 4,328,178; 4,239,716; 4,392,896; 4,645,548; 5,320,677; 5,817,262; and 7,413,603.

The strength ingredients as described herein according to embodiments of the invention also can be used in various types of acoustical panels (e.g., ceiling tile). The starch can be mixed with calcined gypsum, water, and other ingredients as desired in some embodiments. However, the strength ingredients in accordance with some embodiments is not limited to use with calcined gypsum. The strength ingredients in accordance with some embodiments can enhance strength with non-setting components such as fibers (e.g., mineral wool and the like). In some embodiments, the panel has a Noise Reduction Coefficient of at least about 0.5 (e.g., at least about 0.7 or at least about 1) according to ASTM C 423-02. See, e.g., U.S. Pat. Nos. 1,769,519; 6,443,258; 7,364,015; 7,851,057; and 7,862,687 for discussion of ingredients and methods for making acoustical tile.

The invention is further illustrated by the following exemplary embodiments. However, the invention is not limited by the following embodiments.

(1) A cover sheet, gypsum board, slurry, or method of making gypsum board as described herein.

(2) A method of preparing gypsum board comprising: (a) providing a first cover sheet; (b) applying one or more of the following ingredients to an inner surface of the first cover sheet: starch, an electrolyte, and a hydrophilic material; (c) mixing a slurry comprising stucco and water; (d) disposing the slurry between the first cover sheet and a second cover sheet to form an assembly, the slurry facing the inner surface of the cover sheet; (e) cutting the assembly into a board; and (f) drying the board.

(3) The method of embodiment 2, wherein the ingredients are applied to the first cover sheet by spraying, rolling or flood-coating.

(4) The method of embodiments 2 or 3, wherein the ingredients are wet or dried on the first cover sheet prior to disposing the slurry between the first and second cover sheets.

(5) The method of any one of embodiments 2-4, wherein the ingredients include at least one uncooked starch and/or an electrolyte, wherein the electrolyte is a catalyst for hydration of the uncooked starch.

(6) The method of any one of embodiments 2-5, wherein the ingredients include at least one uncooked starch having a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

(7) The method of any one of embodiments 2-6, wherein the uncooked starch has a cold-water viscosity of about 1 centipoise to about 500 centipoise, such as about 1 centipoise to about 100 centipoise, or about 1 centipoise to about 50 centipoise.

(8) The method of any of embodiments 2-7, wherein the ingredients include at least one electrolyte, and the electrolyte includes magnesium nitrate hexahydrate, sodium chloride, calcium nitrate, magnesium chloride, calcium nitrite, magnesium nitrite, or any combination thereof.

(9) The method of embodiment 8, wherein the electrolyte comprises magnesium nitrate hexahydrate.

(10) The method of any one of embodiments 2-9, wherein the electrolyte is included in an amount from about 0.1 lbs/MSF to about 35 lbs/MSF, such as from about 2 lbs/MSF to about 35 lbs/MSF, or from about 0.1 lbs/MSF to about 0.5 lbs/MSF, of the first cover sheet.

(11) The method of any one of embodiments 2-10, wherein the ingredients include at least one hydrophilic material and the hydrophilic material comprises cellulosic material and/or hydrophilic polymer.

(12) The method of embodiment 11, wherein the hydrophilic material includes a cellulosic material having a molecular weight from about 1000 Daltons to about 100,000 Daltons, such as from about 3000 Daltons to about 5000 Daltons.

(13) The method of embodiments 11 or 12, wherein the hydrophilic material includes polymer comprising polyvinyl alcohol.

(14) The method of embodiment 13, wherein the polyvinyl alcohol has a molecular weight from about 20,000 Daltons to about 30,000 Daltons.

(15) The method of any one of embodiments 11-14, wherein the hydrophilic material is included in an amount from about 0.1 lbs/MSF to about 35 lbs/MSF, such as from about 2 lbs/MSF to about 35 lbs/MSF or from about 0.1 lbs/MSF to about 0.5 lbs/MSF, of the first cover sheet.

(16) The method of any one of embodiments 2-15, wherein the ingredient includes a starch, the starch comprising a pregelatinized starch.

(17) The method of embodiment 16, wherein the pregelatinized starch has a viscosity of from about 20 centipoise to about 500 centipoise, as measured according to the VMA method.

(18) The method of any one of embodiment 2-17, wherein the ingredients include starch comprising an uncooked starch and a pregelatinized starch.

(19) The method of embodiment 18, wherein the ratio of pregelatinized starch to uncooked starch is from about 10:90 to about 30:70.

(20) The method of embodiments 18 or 19, wherein the pregelatinized starch has a viscosity of from about 20 centipoise to about 500 centipoise, as measured according to the VMA method, and the uncooked starch has a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

(21) The method of any one of embodiments 6 and 16-20, wherein the ingredients include starch in an amount from about 2 lbs/MSF to about 35 lbs/MSF, such as from about 6 lbs/MSF to about 20 lbs/MSF, of the first cover sheet.

(22) The method of any one of embodiments 2-21, wherein the ingredients include an uncooked starch, a pregelatinized starch, magnesium nitrate hexahydrate, and polyvinyl alcohol.

(23) The method of embodiment 22, wherein the ratio of pregelatinized starch to uncooked starch is from about 10:90 to about 30:70, and the polyvinyl alcohol has a molecular weight of from about 20,000 to about 30,000.

(24) The method of embodiment 22 or 23, wherein the pregelatinized starch has a viscosity of from about 20 centipoise to about 500 centipoise, as measured according to the VMA method, and the uncooked starch has a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

(25) The method of any of embodiments 1-24, wherein the additives are included in a composition before being applied to the first cover sheet.

(26) A slurry comprising stucco, water, and ingredients comprising starch and at least one of the following: an electrolyte, and/or a hydrophilic material, wherein, when the slurry is used to make a gypsum core disposed between two cover sheets in a board having a density of about 35 pounds per cubic foot (560 kg/m³) or less, the board has a nail pull resistance of at least about 65 lbs-f according to ASTM 473-10, method B.

(27) The slurry of embodiment 26, wherein the ingredients include at least one uncooked starch and an electrolyte, wherein the electrolyte is a catalyst for hydration of the uncooked starch.

(28) The slurry of embodiments 26 or 27, wherein the ingredients include at least one uncooked starch having a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

(29) The slurry of any one of embodiments 26-28, wherein the uncooked starch has a cold-water viscosity of about 1 centipoise to about 500 centipoise, such as about 1 centipoise to about 100 centipoise, or about 1 centipoise to about 50 centipoise.

(30) The slurry of any one of embodiments 26-29, wherein the ingredients include at least one electrolyte, and the electrolyte includes calcium nitrate, magnesium nitrate, calcium nitrite, magnesium nitrite, sodium chloride, magnesium chloride, or any combination thereof.

(31) The slurry of embodiment 30, wherein the electrolyte comprises magnesium nitrate hexahydrate.

(32) The slurry of any one of embodiments 26-31, wherein the electrolyte is included in an amount from about 0.1% to about 1% by weight of the stucco, such as from about 0.1% to about 0.5% by weight of the stucco.

(33) The slurry of any one of embodiments 26-32, wherein the ingredients include at least one hydrophilic material and the hydrophilic material comprises cellulosic material and/or hydrophilic polymer.

(34) The slurry of embodiment 33, wherein the hydrophilic material includes a cellulosic material having a molecular weight from about 1000 Daltons to about 100,000 Daltons, such as from about 3000 Daltons to about 5000 Daltons.

(35) The slurry of embodiments 33 or 34, wherein the hydrophilic material includes polymer comprising polyvinyl alcohol.

(36) The slurry of embodiment 35, wherein the polyvinyl alcohol has a molecular weight from about 20,000 Daltons to about 30,000 Daltons.

(37) The slurry of any one of embodiments 33-36, wherein the hydrophilic material is included in an amount from about 0.1% to about 5% by weight of the stucco, such as from about 0.1% to about 1% by weight of the stucco.

(38) The slurry of any one of embodiments 26-37, wherein the starch includes a pregelatinized starch.

(39) The slurry of embodiment 38, wherein the pregelatinized starch has a viscosity of from about 20 centipoise to about 500 centipoise, as measured according to the VMA method.

(40) The slurry of any one of embodiments 26-39, wherein the starch includes an uncooked starch and a pregelatinized starch.

(41) The slurry of embodiment 40, wherein the ratio of pregelatinized starch to uncooked starch is from about 10:90 to about 30:70.

(42) The slurry of embodiments 40 or 41, wherein the pregelatinized starch has a viscosity of from about 20 centipoise to about 500 centipoise, as measured according to the VMA method, and the uncooked starch has a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

(43) The slurry of any one of embodiments 26-42, wherein the starch is included in an amount from about 0.1% to about 20% by weight of the stucco, such as from about 0.5% to about 10% by weight of the stucco.

(44) The slurry of any one of embodiments 26-43, wherein the ingredients include an uncooked starch, a pregelatinized starch, magnesium nitrate hexahydrate, and polyvinyl alcohol.

(45) The slurry of embodiment 44, wherein the ratio of pregelatinized starch to uncooked starch is from about 10:90 to about 30:70, and the polyvinyl alcohol has a molecular weight of from about 20,000 to about 30,000.

(46) The slurry of embodiment 44 or 45, wherein the pregelatinized starch has a viscosity of from about 20 centipoise to about 500 centipoise, as measured according to the VMA method, and the uncooked starch has a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

(47) The slurry of any one of embodiments 44-46, wherein the uncooked starch has a cold-water viscosity of about 1 centipoise to about 500 centipoise, such as about 1 centipoise to about 100 centipoise, or about 1 centipoise to about 50 centipoise.

(48) The slurry of any one of embodiments 26-47, wherein the slurry further comprises a dispersant.

(49) The slurry of embodiment 48, wherein the dispersant is naphthalene sulfonate.

(50) The slurry of embodiments 48 or 49, wherein the dispersant is present in an amount of from about 0.1% to about 4% by weight of the stucco.

(51) The slurry of any one of embodiments 26-50, wherein the slurry further comprises a polyphosphate.

(52) The slurry of embodiment 51, wherein the polyphosphate is sodium trimetaphosphate.

(53) The slurry of embodiments 51 or 52, wherein the polyphosphate is present in an amount of from about 0.1% to about 0.3% by weight of the stucco.

(54) The slurry of any one of embodiments 26-53, the slurry having a water-stucco ratio of from about 0.4 to about 1.3.

(55) The slurry of any one of embodiments 26-54, wherein, when the slurry is prepared into a board, the board has a density of from about 14 pcf to about 35 pcf.

(56) A product made from the slurry of any of embodiments 26-55.

(57) A gypsum board comprising: (a) a board core comprising set gypsum formed from a first slurry comprising water, stucco, and optionally, one or more of the following ingredients: starch, an electrolyte, and a hydrophilic material, the core defining a first core face; and (b) a concentrated layer formed from a second slurry of any one of embodiments 25-54, the concentrated layer disposed in bonding relation to the first core face; wherein: (i) when one or more of the starch, electrolyte, and hydrophilic material is included in forming the board core, the starch, electrolyte, and/or hydrophilic material is included in a higher concentration in forming the concentrated layer than in forming the board core, (ii) the board core has a thickness greater than the thickness of the concentrated layer, and, (iii) optionally one or more of the following: (a) the concentrated layer has an average core hardness that is at least about 1.5 times greater than the average core hardness of the board core, (b) when one or more of the starch, electrolyte, and hydrophilic material is present in forming the core, the concentrated layer is formed from at least about 1.2 times the starch, electrolyte, and hydrophilic material used in forming the board core, (c) the board core has a dry density of about 30 pcf or less, (d) the concentrated layer has a dry density of at least about 1.1 times higher than the dry density of the board core, and (e) the first slurry has a first water-stucco ratio and the second slurry has a second water-stucco ratio, the second water-stucco ratio being at least about 1.2 times higher than the first water-stucco ratio.

(58) A gypsum board comprises a set gypsum core disposed between two cover sheets. The core can be formed from a slurry according to any one of embodiments 26-55. The board desirably has a density of about 35 pounds per cubic foot (560 kg/m³) or less, and a nail pull resistance of at least about 65 lbs-f according to ASTM 473-10, method B.

(59) A gypsum board comprises set gypsum core disposed between two cover sheets. The core is formed from a slurry comprising stucco, water, and other optional additives as desired, e.g., migrating starch, non-migrating starch, accelerator, retarder, foam, dispersant, etc. At least one cover sheet contains at least one or more of the following ingredients on an inner surface of the cover sheet: starch, an electrolyte, and a hydrophilic material.

(60) The gypsum board of embodiment 59, wherein the ingredients include at least one uncooked starch and an electrolyte, wherein the electrolyte is a catalyst for hydration of the uncooked starch.

(61) The gypsum board of embodiments 59 or 60, wherein the ingredients include at least one uncooked starch having a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

(62) The gypsum board of any one of embodiments 59-61, wherein the uncooked starch has a cold-water viscosity of about 1 centipoise to about 500 centipoise, such as about 1 centipoise to about 100 centipoise, or about 1 centipoise to about 50 centipoise.

(63) The gypsum board of any of embodiments 59-62, wherein the ingredients include at least one electrolyte, and the electrolyte includes magnesium nitrate hexahydrate, sodium chloride, calcium nitrate, magnesium chloride, calcium nitrate, magnesium nitrate, or any combination thereof.

(64) The gypsum board of embodiment 63, wherein the electrolyte comprises magnesium nitrate hexahydrate.

(65) The gypsum board of any one of embodiments 59-64, wherein the electrolyte is included in an amount from about 0.1 lbs/MSF to about 35 lbs/MSF, such as from about 2 lbs/MSF to about 35 lbs/MSF, or from about 0.1 lbs/MSF to about 0.5 lbs/MSF, of the first cover sheet.

(66) The gypsum board of any one of embodiments 59-65, wherein the ingredients include at least one hydrophilic material and the hydrophilic material comprises cellulosic material and/or hydrophilic polymer.

(67) The gypsum board of embodiment 66, wherein the hydrophilic material includes a cellulosic material having a molecular weight from about 1000 Daltons to about 100,000 Daltons, such as from about 3000 Daltons to about 5000 Daltons.

(68) The gypsum board of embodiments 66 or 67, wherein the hydrophilic material includes a polymer having a molecular weight from about 20,000 Daltons to about 30,000 Daltons.

(69) The gypsum board of embodiments 66 or 67, wherein the polymer is polyvinyl alcohol.

(70) The gypsum board of any one of embodiments 66-69, wherein the hydrophilic material is included in an amount from about 0.1 lbs/MSF to about 35 lbs/MSF, such as from about 2 lbs/MSF to about 35 lbs/MSF, or from about 0.1 lbs/MSF to about 0.5 lbs/MSF by weight of the stucco.

(71) The gypsum board of any one of embodiments 59-70, wherein the starch includes a pregelatinized starch.

(72) The gypsum board of embodiment 71, wherein the pregelatinized starch has a viscosity of from about 20 centipoise to about 500 centipoise, as measured according to the VMA method.

(73) The gypsum board of any one of embodiments 59-72, wherein the ingredients include starch comprising an uncooked starch and a pregelatinized starch.

(74) The gypsum board of embodiment 73, wherein the ratio of pregelatinized starch to uncooked starch is from about 10:90 to about 30:70.

(75) The gypsum board of embodiments 73 or 74, wherein the pregelatinized starch has a viscosity of from about 20 centipoise to about 500 centipoise, as measured according to the VMA method, and the uncooked starch has a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

(76) The gypsum board of any one of embodiments 59-75, wherein the ingredients include starch in an amount from about 2 lbs/MSF to about 35 lbs/MSF, such as from about 6 lbs/MSF to about 20 lbs/MSF, of the first cover sheet.

(77) The gypsum board of any one of embodiments 58-75, wherein the ingredients include an uncooked starch, a pregelatinized starch, magnesium nitrate hexahydrate, and polyvinyl alcohol.

(78) The gypsum board of embodiment 77, wherein the ratio of pregelatinized starch to uncooked starch is from about 10:90 to about 30:70, and the polyvinyl alcohol has a molecular weight of from about 20,000 to about 30,000.

(79) The gypsum board of embodiment 77 or 78, wherein the pregelatinized starch has a viscosity of from about 20 centipoise to about 500 centipoise, as measured according to the VMA method, and the uncooked starch has a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

(80) The gypsum board of any one of embodiments 77-79, wherein the uncooked starch has a cold-water viscosity of about 1 centipoise to about 500 centipoise, such as about 1 centipoise to about 100 centipoise, or about 1 centipoise to about 50 centipoise.

(81) A cover sheet having a major inner surface and a major outer surface, the major inner surface containing one or more of the following ingredients: starch, an electrolyte, and a hydrophilic material.

(82) The cover sheet of embodiment 81, wherein the ingredients are applied to the cover sheet by spraying, rolling or flood-coating.

(83) The cover sheet of embodiments 81 or 82, wherein the ingredients include at least one uncooked starch and/or an electrolyte, wherein the electrolyte is a catalyst for hydration of the uncooked starch.

(84) The cover sheet of any one of embodiments 81-83, wherein the ingredients include at least one uncooked starch having a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

(85) The cover sheet of any one of embodiments 81-84, wherein the uncooked starch has a cold-water viscosity of about 1 centipoise to about 500 centipoise, such as about 1 centipoise to about 100 centipoise, or about 1 centipoise to about 50 centipoise.

(86) The cover sheet of any of embodiments 81-85, wherein the ingredients include at least one electrolyte, and the electrolyte includes magnesium nitrate hexahydrate, sodium chloride, calcium nitrate, magnesium chloride, calcium nitrite, magnesium nitrite, or any combination thereof.

(87) The cover sheet of embodiment 86, wherein the electrolyte comprises magnesium nitrate hexahydrate.

(88) The cover sheet of any one of embodiments 81-87, wherein the electrolyte is included in an amount from about 0.1 lbs/MSF to about 35 lbs/MSF, such as from about 2 lbs/MSF to about 35 lbs/MSF, or from about 0.1 lbs/MSF to about 0.5 lbs/MSF, of the cover sheet.

(89) The cover sheet of any one of embodiments 81-88, wherein the ingredients include at least one hydrophilic material and the hydrophilic material comprises cellulosic material and/or hydrophilic polymer.

(90) The cover sheet of embodiment 89, wherein the hydrophilic material includes a cellulosic material having a molecular weight from about 1000 Daltons to about 100,000 Daltons, such as from about 3000 Daltons to about 5000 Daltons.

(91) The cover sheet of embodiments 89 or 90, wherein the hydrophilic material includes polymer comprising polyvinyl alcohol.

(92) The cover sheet of embodiment 91, wherein the polyvinyl alcohol has a molecular weight from about 20,000 Daltons to about 30,000 Daltons.

(93) The cover sheet of any one of embodiments 89-92, wherein the hydrophilic material is included in an amount from about 0.1 lbs/MSF to about 35 lbs/MSF, such as from about 2 lbs/MSF to about 35 lbs/MSF or from about 0.1 lbs/MSF to about 0.5 lbs/MSF, of the cover sheet.

(94) The cover sheet of any one of embodiments 81-93, wherein the ingredient includes a starch, the starch comprising a pregelatinized starch.

(95) The cover sheet of embodiment 94, wherein the pregelatinized starch has a viscosity of from about 20 centipoise to about 500 centipoise, as measured according to the VMA method.

(96) The cover sheet of any one of embodiments 81-95, wherein the ingredients include starch comprising an uncooked starch and a pregelatinized starch.

(97) The cover sheet of embodiment 96, wherein the ratio of pregelatinized starch to uncooked starch is from about 10:90 to about 30:70.

(98) The cover sheet of embodiments 96 or 97, wherein the pregelatinized starch has a viscosity of from about 20 centipoise to about 500 centipoise, as measured according to the VMA method, and the uncooked starch has a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

(99) The cover sheet of any one of embodiments 84 and 94-98, wherein the ingredients include starch in an amount from about 2 lbs/MSF to about 35 lbs/MSF, such as from about 6 lbs/MSF to about 20 lbs/MSF, of the cover sheet.

(100) The cover sheet of any one of embodiments 81-99, wherein the ingredients include an uncooked starch, a pregelatinized starch, magnesium nitrate hexahydrate, and polyvinyl alcohol.

(101) The cover sheet of embodiment 100, wherein the ratio of pregelatinized starch to uncooked starch is from about 10:90 to about 30:70, and the polyvinyl alcohol has a molecular weight of from about 20,000 to about 30,000.

(102) The cover sheet of embodiment 100 or 101, wherein the pregelatinized starch has a viscosity of from about 20 centipoise to about 500 centipoise, as measured according to the VMA method, and the uncooked starch has a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

(103) The cover sheet of any one of embodiments 81-102, wherein the ingredients are dried on the inner surface of the sheet.

(104) The cover sheet of any one of embodiments 81-103, wherein the ingredients are included in a composition and then added to the inner surface of the cover sheet.

It shall be noted that the preceding are merely examples of embodiments. Other exemplary embodiments are apparent from the entirety of the description herein. It will also be understood by one of ordinary skill in the art that each of these embodiments may be used in various combinations with the other embodiments provided herein.

The following examples further illustrate the invention but, of course, should not be construed as in any way limiting its scope.

### Example 1

This example demonstrates the strength performance of two sample boards (1A and 1B, respectively), in comparison with a control board. The boards were made with production stucco slurry and dried in laboratory. The boards included two cover sheets, with a cover sheet disposed in bonding relation to each, generally parallel, major surface of a gypsum core. Sample Boards 1A and 1B contained strength ingredients that were applied on an inner surface (facing the core) of the face cover sheet, while the control did not include the strength ingredients on the cover sheet. None of the boards contained a skim coat, i.e., a dense, bonding layer between the core and either cover sheet.

Table 1 provides the formulation of strength ingredient compositions 1A and 1B used with board samples 1A and 1B, respectively. As seen in Table 1, the strength ingredient compositions 1A and 1B contained a combination of starches in the form of a proportionally formulated mixture of pregelatinized (cooked) corn starch (viscosity of 100 centipoise according to the VMA method) and an acid modified uncooked starch having a peak viscosity of 451 BU (Clinton 260, manufactured by Archer Daniels Midland (ADM), Chicago, Ill.). Composition 1B also included polyvinyl alcohol and magnesium nitrate hexahydrate. The polyvinyl alcohol had a molecular weight of 5000 (Selvol 205S, Sekisui Specialty Chemicals, Dallas Tex.). The composition was applied to the cover sheet of the respective board sample by means of roll coating on the inside surface of the face paper (facing the core slurry) immediately prior to contact with the gypsum slurry. The board samples were made with pre-made envelopes and molded to a ½-inch thickness. Board samples 1A and 1B each had a board density of 1300 lbs/msf.

TABLE 1

| | Additive | | Additive | |
|---|---|---|---|---|
| | Composition 1A | | Composition 1B | |
| Ingredients | Grams | Wt. % | Grams | Wt. % |
| Water | 140 | 70 | 140 | 70 |
| Uncooked acid-modified | 48 | 24 | 44 | 22 |
| starch having a peak | | | | |
| viscosity of 451 BU | | | | |
| (Clinton 260) | | | | |
| Pregelatinized corn | 12 | 6 | 12 | 12 |
| starch having a | | | | |
| viscosity of 100 | | | | |
| centipoise according | | | | |
| to the VMA method | | | | |
| Magnesium nitrate | — | — | 2 | 1 |
| hexahydrate | | | | |
| Polyvinyl alcohol | — | — | 2 | 1 |
| (Sevol 205S) | | | | |

Table 2 provides the gypsum core slurry compositions used to form the board core of the respective board samples. The core is normally formed from stucco and water, and optional ingredients as desired.

TABLE 2

| Ingredients | Amount (Lbs/MSF) | Weight Percentage |
|---|---|---|
| Stucco | 980 | 53.25 |
| Gauging water | 717 | 38.96 |
| Foam water | 85.5 | 4.56 |
| Soap | 0.54 | 0.49 |
| Heat Resistant | 9.04 | 0.50 |
| Accelerator | | |
| Pregel. Starch | 12.03 | 0.65 |
| Dispersant | 4.01 | 0.22 |
| Retarder | 0.3 | 0.02 |
| Sodium Trimetaphosphate | 15.01 | 0.82 |

The gypsum core slurries were formed in a commercial production mixer. Dry ingredients included the stucco, the heat resistant accelerator, which was in the form of grounded gypsum, and the starch, which was pre-gelled starch having a viscosity of 773 centipoise as measured according to the VMA method.

Total water included water included from gauging water, retarder water, dispersant water, and soap water. Gauging water refers to the water used for mixing with stucco in the slurry as known in the art. The core nominally had a water/stucco ratio of 0.85, although other water/stucco ratios as described herein are possible.

Regarding the wet ingredients, for foam preparation, a 0.5% solution of Hyonic™ PFM-33 soap (available from GEO Specialty Chemicals, Ambler, Pa.) was formed and then mixed with air to make the air foam. The air foam was added to the slurry using a foam generator. The dispersant was in the form of a poly naphthalene sulfonate calcium salt (DURASAR™ commercially from Ruetgers Polymers, Candiac, Canada). The sodium trimetaphosphate was in a 10% solution of phosphate in water, prepared by dissolving 10 parts (weight) of sodium trimetaphosphate in 90 parts (weight) of water, while the retarder was in a 1% solution and was composed of an aqueous solution of pentasodium salt of diethylenetriaminepentaacetic acid (Versenex™ 80, commercially available from DOW Chemical Company, Midland, Mich.), and prepared by mixing 1 part (weight) of Versenex™ 80 with 99 parts (weight) of water. Other amounts for these optional ingredients in the board core slurry can be used as described herein.

The board samples were dried at 450° F. (approximately 230° C.) for 10 minutes and conditioned at 110° F. (approximately 40° C.) for 48 hours before testing.

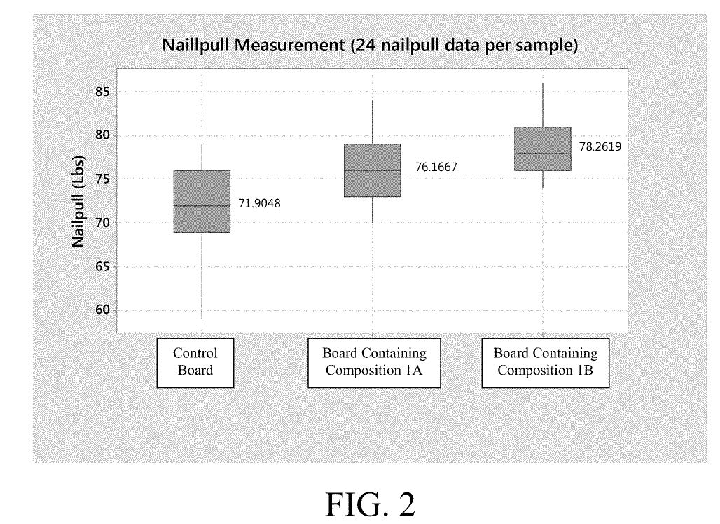

The results are shown in FIG. 2. As seen in FIG. 2, the nail pull resistance is enhanced in the board samples 1A and 1B, which contained a cover sheet with strength ingredient Composition 1A or 1B, respectively, as compared with the control board, which did not contain the strength ingredients on the cover sheet, although the control also exhibited good strength. This demonstrates that the formulations of samples 1A and 1B enhanced the overall board strength. As an advantage, without wishing to be bound by any particular theory, use of the strength ingredients allows for increasing board strength by enhancing the hydrogen bonding between the cover sheet (e.g., paper) and gypsum core and without requiring increase in density.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. “Bonding relation” does not mean that two layers are in direct contact. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of preparing gypsum board comprising:
providing a first cover sheet having a first surface;
applying one or more of the following ingredients to the first surface of the first cover sheet: starch, an electrolyte, and a hydrophilic material;
mixing a slurry comprising stucco and water;
disposing the slurry between the first cover sheet and a second cover sheet to form an assembly, the slurry facing the first surface of the cover sheet;
cutting the assembly into a board; and
drying the board.

2. The method of claim 1, the ingredients including an uncooked starch and an electrolyte;
the uncooked starch having a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute;
the uncooked starch having a cold-water viscosity of about 1 centipoise to about 500 centipoise; and
the electrolyte including magnesium nitrate hexahydrate, sodium chloride, calcium nitrate, magnesium chloride, calcium nitrite, or magnesium nitrite, or any combination thereof.

3. The method of claim 2, the ingredients further including hydrophilic material comprising cellulosic material having a molecular weight of from about 1,000 Daltons to about 100,000 Daltons and/or polyvinyl alcohol.

4. The method of claim 3, wherein the hydrophilic material includes polyvinyl alcohol having a molecular weight of from about 20,000 Daltons to about 30,000 Daltons.

5. The method of claim 1, the ingredients including starch and an electrolyte; the starch comprising a pregelatinized starch having a viscosity of from about 20 centipoise to about 500 centipoise, as measured according to the VMA method; and the electrolyte including magnesium nitrate hexahydrate, sodium chloride, calcium nitrate, magnesium chloride, calcium nitrite, or magnesium nitrite, or any combination thereof.

6. The method of claim 1, wherein the ingredients include starch comprising an uncooked starch and a pregelatinized starch.

7. The method of claim 6,
the pregelatinized starch having a viscosity of from about 20 centipoise to about 500 centipoise, as measured according to the VMA method; and
the uncooked starch having a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

8. The method of claim 1, wherein the ingredients include uncooked starch, pregelatinized starch, magnesium nitrate hexahydrate, and polyvinyl alcohol.

9. The method of claim 1, the ingredients including an electrolyte and a hydrophilic material;
the electrolyte including magnesium nitrate hexahydrate, sodium chloride, calcium nitrate, magnesium chloride, calcium nitrite, or magnesium nitrite, or any combination thereof; and
the hydrophilic material comprising cellulosic material having a molecular weight of from about 1,000 Daltons to about 100,000 Daltons and/or polyvinyl alcohol.

10. A slurry comprising stucco, water, and ingredients comprising starch and at least one of the following: an electrolyte or a hydrophilic material, wherein, when the slurry is used to make a gypsum core disposed between two cover sheets in a board having a density of about 35 pounds per cubic foot (560 kg/m³) or less, the board has a nail pull resistance of at least about 72 lbs-f according to ASTM 473-10, method B.

11. The slurry of claim 10, the ingredients including uncooked starch, pregelatinized starch, and an electrolyte;
the uncooked starch having a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute;
the uncooked starch having a cold-water viscosity of about 1 centipoise to about 500 centipoise;
the pregelatinized starch having a viscosity of from about 20 centipoise to about 500 centipoise, as measured according to the VMA method; and
the electrolyte including calcium nitrate, magnesium nitrate, calcium nitrite, magnesium nitrite, sodium chloride, or magnesium chloride, or any combination thereof.

12. The slurry of claim 11, the ingredients including hydrophilic material comprising cellulosic material having a molecular weight of from about 1,000 Daltons to about 100,000 Daltons and/or polyvinyl alcohol.

13. The slurry of claim 10, the ingredients including hydrophilic material comprising cellulosic material having a molecular weight of from about 1,000 Daltons to about 100,000 Daltons and/or polyvinyl alcohol.

14. A gypsum board comprising:
a set gypsum layer disposed between two cover sheets, the gypsum layer formed from a slurry comprising stucco and water,
at least one cover sheet having a first surface and containing at least one or more of the following ingredients on the first surface of the cover sheet: starch, an electrolyte, and a hydrophilic material.

15. The gypsum board of claim 14, the ingredients including uncooked starch and electrolyte;
the uncooked starch having a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute;
the uncooked starch having a cold-water viscosity of about 1 centipoise to about 500 centipoise; and
the electrolyte including magnesium nitrate hexahydrate, sodium chloride, calcium nitrate, magnesium chloride, calcium nitrite, or magnesium nitrite, or any combination thereof.

16. The gypsum board of claim 14, the ingredients including a starch and an electrolyte; the starch comprising a pregelatinized starch having a viscosity of from about 20 centipoise to about 500 centipoise, as measured according to the VMA method; and the electrolyte including magnesium nitrate hexahydrate, sodium chloride, calcium nitrate, magnesium chloride, calcium nitrite, or magnesium nitrite, or any combination thereof.

17. The gypsum board of claim 14, the ingredients including uncooked starch, pregelatinized starch, and an electrolyte;
the uncooked starch having a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute;
the uncooked starch having a cold-water viscosity of from about 1 centipoise to about 500 centipoise;
the pregelatinized starch having a viscosity of from about 20 centipoise to about 500 centipoise, as measured according to the VMA method; and
the electrolyte including calcium nitrate, magnesium nitrate, calcium nitrite, magnesium nitrite, sodium chloride, or magnesium chloride, or any combination thereof.

18. The gypsum board of claim 15, the ingredients including hydrophilic material comprising cellulosic material having a molecular weight of from about 1,000 Daltons to about 100,000 Daltons and/or polyvinyl alcohol.

19. The gypsum board of claim 14, the ingredients including the electrolyte and the hydrophilic material;
the electrolyte including calcium nitrate, magnesium nitrate, calcium nitrite, magnesium nitrite, sodium chloride, or magnesium chloride, or any combination thereof; and
the hydrophilic material comprising cellulosic material having a molecular weight of from about 1,000 Daltons to about 100,000 Daltons and/or polyvinyl alcohol.

20. The gypsum board of claim 14, the ingredients including starch and hydrophilic material;
the starch comprising (a) uncooked starch having a peak viscosity of from about 100 Brabender Units to about 900 Brabender units when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute, and/or (b) pregelatinized starch having a viscosity of from about 20 centipoise to about 500 centipoise, as measured according to the VMA method; and
the hydrophilic material comprising cellulosic material having a molecular weight of from about 1,000 Daltons to about 100,000 Daltons and/or polyvinyl alcohol.
